(19) United States
(12) Patent Application Publication
(10) Pub. No.: US 2016/0363109 A1
(43) Pub. Date: Dec. 15, 2016

(54) SYSTEM FOR CONTROLLING ENGINE

(71) Applicant: DENSO CORPORATION, Kariya-city (JP)

(72) Inventors: Toshikazu AKITA, Kariya-city (JP); Shigeru MAEDA, Kariya-city (JP); Tomohisa OSE, Kariya-city (JP); Ikuro HASHIMOTO, Kariya-city (JP)

(21) Appl. No.: 15/177,500

(22) Filed: Jun. 9, 2016

(30) Foreign Application Priority Data
Jun. 9, 2015 (JP) 2015-116933

(51) Int. Cl. F02P 5/145; F02B 63/04

(52) U.S. Cl. CPC F02P 5/145; F02B 63/04

(57) ABSTRACT

In a system for controlling an engine that ignites an air-fuel mixture to generate torque, a power generator, and a secondary battery is chargeable by the power generator. An apparatus controls the engine to adjust an actual point of ignition timing of the air-fuel mixture to a desired point of the ignition timing. The apparatus causes the power generator to generate electric power based on output torque of the engine. The output torque of the engine is generated while the actual point of the ignition timing is set to the desired point of the ignition timing. The apparatus adjusts the amount of the electric power generated by the power generator while the actual point of the ignition timing of the engine is set to the desired point of the ignition timing, thus changing the output torque of the engine.

### CROSS REFERENCE TO RELATED APPLICATIONS

This application is based on and claims the benefit of priority from Japanese Patent Application 2015-116933 filed on Jun. 9, 2015, the disclosure of which is incorporated in its entirety herein by reference.

### TECHNICAL FIELD

The present disclosure relates to systems for controlling an engine. In particular, the present disclosure relates to such systems for adjusting, according to request torque for the output torque of the engine, both the quantity of intake air into the engine and the ignition timing in the engine to control the output torque of the engine accordingly.

### BACKGROUND

Typical control systems for internal combustion engines, which are simply referred to as engines, adjust, according to request torque for the output torque of an engine, both the quantity of intake air into the engine and the ignition timing in the engine to control the output torque of the engine accordingly.

These control systems increase the quantity of intake air into the engine according to the increase of the request torque to compensate for the increment of the request torque. Unfortunately, the responsivity of the output torque with respect to change of the quantity of intake air may be low, resulting in delay of change of the output torque in response to the increment of the request torque.

As compared with change of the quantity of intake air, the output torque has higher responsivity with respect to change of the ignition timing.

In view of this point, typical ignition-timing control adjusts the actual point of the ignition timing to the optimum point of the ignition timing, which is called Minimum advance for the Best torque, MBT; the ignition timing adjusted to the MBT results in maximum torque and best fuel consumption of the engine. The typical ignition-timing control may therefore result in the adjusted point of the ignition timing having insufficient margin relative to the MBT in the direction of advance.

In view of these circumstances, a known control system disclosed in Japanese Patent Application Publication 2008-128082 performs so-called torque reserve control. The torque reserve control voluntarily retards the actual point of ignition timing from the MBT by a predetermined torque margin; this torque margin is also called reserve torque. This ignition-timing retardation decreases beforehand the output torque. The known control system advances the retarded point of the ignition timing by the torque margin in response to an increase of the request torque to increase the output torque immediately. This results in the higher responsivity of the output torque with respect to an increase of the request torque.

### SUMMARY

Unfortunately, the torque reserve control voluntarily retards the actual point of the ignition timing from the MBT to decrease the output torque, resulting in deterioration of the fuel consumption of the engine.

Additionally, when the request torque is higher than the reserve torque, the known control system increases the quantity of intake air into the engine. This may fail to increase the output torque for a certain amount of time until flow of air in the engine because of the low responsivity of the output torque with respect to change of the quantity of intake air. In other words, this may result in time loss from an increase of the request torque to actual generation of the output torque in response to the increase of the request torque.

In view of the circumstances set forth above, an exemplary aspect of the present disclosure seeks to provide systems for controlling an engine, each of which has higher responsivity of output torque with respect to change of request torque, resulting in improvement of the fuel consumption of the engine.

According to a first exemplary aspect of the present disclosure, there is provided a system for controlling an engine that ignites an air-fuel mixture to generate torque. The system includes a power generator, a secondary battery chargeable by the power generator, and an apparatus. The apparatus is configured to control the engine to adjust an actual point of ignition timing of the air-fuel mixture to a predetermined point thereof of the ignition timing. The apparatus is configured to cause the power generator to generate electric power based on output torque of the engine. The output torque of the engine is generated while the actual point of the ignition timing is set to the desired point of the ignition timing. The apparatus is configured to adjust an amount of the electric power generated by the power generator while the actual point of the ignition timing of the engine is set to the desired point of the ignition timing, thus changing the output torque of the engine.

The system according to the first exemplary aspect of the present disclosure causes the power generator to generate electric power based on output torque of the engine, thus reserving torque without retarding the actual point of the ignition timing from the desired point of the ignition timing. This maintains higher fuel economy because there is no retardation of the actual point of the ignition timing from the desired point of the ignition timing. Additionally, the apparatus adjusts the amount of electric power generated by the power generator to change the output torque of the engine without performing intake-air control. This achieves higher responsivity of the output torque of the engine in response to a request for changing the output torque of the engine.

According to a second exemplary aspect of the present disclosure, there is provided a system for controlling an engine that ignites an air-fuel mixture to generate torque. The system includes a power generator, a secondary battery chargeable by the power generator, and a motor configured to generate, based on output power of the secondary battery, torque for the engine. The system also includes an apparatus configured to control the engine to adjust an actual point of ignition timing of the air-fuel mixture to a desired point of the ignition timing and to reduce a quantity of intake air into the engine to be lower than a predetermined quantity of intake air into the engine. The apparatus is configured to cause the power generator to generate electric power based on output torque of the engine. The output torque of the engine is generated while the actual point of the ignition timing is set to the desired point of the ignition timing. The apparatus is configured to adjust an amount of the torque generated by the motor while the actual point of the ignition timing of the engine is set to the desired point of the ignition timing, thus changing the output torque of the engine.

Although the system according to the second exemplary aspect of the present disclosure has no torque reserve because of there being no retardation of the actual point of the ignition timing from the desired point of the ignition timing, the system adjusts the amount of the torque generated by the motor in response to a request for changing the output torque of the engine. This therefore achieves higher fuel economy and higher responsivity of the output torque of the engine in response to a request for changing the output torque of the engine.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more features of other embodiments where applicable. The descriptions of features, and/or advantages of particular embodiments should not be construed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a circuit diagram schematically illustrating an overall configuration of a system for controlling an internal combustion engine according to the first embodiment of the present disclosure;

FIG. 2 is a flowchart schematically illustrating a routine, which corresponds to a first output-torque control task, carried out by a control apparatus illustrated in FIG. 1;

FIG. 3 is a graphic view schematically illustrating how torque generated by an engine illustrated in FIG. 1 changes according to the first embodiment in comparison to how torque generated by the same engine changes according to a comparison example 1;

FIG. 4 is a flowchart schematically illustrating a routine, which corresponds to a second output-torque control task, carried out by a control apparatus according to the first embodiment of the present disclosure;

FIG. 5 is a graphic view schematically illustrating how torque generated by the engine changes according to the second embodiment in comparison to how torque generated by the same engine changes according to the comparison example 1;

FIG. 6 is a flowchart schematically illustrating a routine, which corresponds to a third output-torque control task, carried out by a control apparatus according to the third embodiment of the present disclosure;

FIG. 7 is a flowchart schematically illustrating a routine, which corresponds to a fourth output-torque control task, carried out by a control apparatus according to the fourth embodiment of the present disclosure; and

FIG. 8 is a graphic view schematically illustrating how torque generated by the engine changes according to the fourth embodiment in comparison to how torque generated by the same engine changes according to the comparison example 1.

### DETAILED DESCRIPTION OF EMBODIMENT

The following describe specific embodiments of the present disclosure with reference to the accompanying drawings. The following omits or simplifies descriptions of like parts between the embodiments, to which identical or like reference characters are assigned, thus eliminating redundant descriptions. Various combinations of the embodiments can be carried out as long as there are no inconsistences in each of the combinations. One or more components disclosed in one of the embodiments can be combined with one or more components disclosed in another one of the embodiments.

### First Embodiment

The following describes a system for controlling an internal combustion engine, referred to as an engine, 11 according to the first embodiment of the present disclosure with reference to the accompanying drawings.

The control system according to the first embodiment is designed as a part of a parallel hybrid system PHS installed in a vehicle 100. The parallel hybrid system PHS includes an apparatus 10, referred to as a control apparatus 10, for controlling the engine 11, driving wheels 12, a transmission (T/M) 13, a clutch 14, a motor-generator (MG) 15, a secondary battery 16, and electrical loads 17.

The engine 11 includes an output shaft 11a having a first end and a second end opposite to the first end. The engine 11 is operative to compress air-fuel mixture or air by the piston within each cylinder and burn the compressed air-fuel mixture or the mixture of the compressed air and fuel within each cylinder. This changes the fuel energy to mechanical energy, such as rotational energy, to reciprocate the piston within each cylinder, thus generating torque of the output shaft 11a based on the mechanical energy. The first end of the output shaft 11s is coupled to the clutch 14, and, on the second end of the output shaft 11a, a first pulley P1 is mounted. The first pulley P1 has an outer circumference on which a belt 15a is wound.

The engine 11 includes a fuel injection system 51 and an ignition system 52.

The fuel injection system 51 includes actuators, such as fuel injectors, for the respective cylinders of the engine 11, causes each fuel injector to spray fuel either directly into a corresponding one of the cylinders of the engine 11 or into an intake manifold (or intake port) just ahead of the cylinders. This burns the air-fuel mixture in each cylinder of the engine 11.

The ignition system 52 includes actuators, such as igniters 52a, for the respective cylinders of the engine 11, and causes each igniter 52a to provide an electric current or spark to ignite an air-fuel mixture in a corresponding one of the cylinders of the engine 11, thus burning the air-fuel mixture.

When the engine 11 is designed as a diesel engine, the ignition system 52 can be eliminated.

The engine 11 also includes a valve system 53 equipped with a plurality of camshafts, intake valves, and exhaust valves. Each of the camshafts is driven by gears, a belt, or a chain from the output shaft 11a, and is designed to turn at half the speed of the output shaft 11a. At least one of the camshafts is operative to cause the intake valves in the engine 11 to open and close, thus enabling intake air to enter the engine 11. Another at least one of the camshafts is operative to cause the exhaust valves in the engine 11 to open and close, thus enabling exhaust air to be discharged from the engine 11.

The engine 11 also includes a throttle system 54 comprised of a driver-operable accelerator pedal, a throttle valve TV mounted in an intake pipe of the engine 11 and linked to the accelerator pedal, and a driver for controllably driving the throttle valve TV. That is, the throttle valve TV is configured to control the amount of intake air to the engine 11 according to an actual position of the accelerator pedal under control of the driver.

The clutch 14 is operative to connect or disconnect the second end of the output shaft 11a to the transmission 13 according to driver's operation of, for example, an unillustrated clutch pedal. The transmission 13 is coupled between the clutch 14 and the driving wheels 12 via a driving shaft 12a. The transmission 13 uses gearing or torque conversion to change the torque ratio (gear ratio) between the Revolutions Per Minute (RPM) of the output shaft 11a and the RPM of the driving wheels 12. That is, the transmission 13 changes torque of the output shaft 11a generated by the engine 11 according to the torque ratio.

That is, the clutch 14 is engaged to connect the second end of the output shaft 11a to the transmission 13 when there is no depression of the clutch pedal, enabling the RPM of the output shaft 11a to be transferred to the driving wheels 12 via the transmission 14. This results in transfer of driving torque, generated based on the torque of the output shaft 11a generated by the engine 11 and the torque ratio, to the driving wheels 12.

On the other hand, the clutch 14 is disengaged to disconnect the second end of the output shaft 11a from the transmission 13 when there is depression of the clutch pedal, disabling the RPM of the output shaft 11a from being transferred to the driving wheels 12 via the transmission 14. This results in interruption of transfer of driving torque, generated based on the torque of the output shaft 11a generated by the engine 11 and the torque ratio, to the driving wheels 12.

For example, the motor-generator 15 includes a stator with multiphase armature windings, a rotor rotatable with respect to the stator, and an output shaft mounted to the rotor. A second pulley P2 is mounted on the output shaft. The second pulley P2 has an outer circumference on which the belt 15a is wound.

Torque of the output shaft 11a generated by the engine 11 is transferred to the motor-generator 15 via the first pulley P1, the belt 15a, and the second pulley P2. This causes the rotor of the motor-generator 15 to rotate. The rotation of the rotor of the motor-generator 15 generates alternating-current (AC) power in the multiphase armature windings, and the motor-generator 15 rectifies the AC power into direct-current (DC) power. That is, the torque supplied from the engine 11 to the motor-generator 15 causes the motor-generator 15 to serve as a power generator, i.e. an alternator, thus generating DC power. The motor-generator 15 is connected to the secondary battery 16, so that the DC power generated by the motor-generator 15 charges the secondary battery 16. For example, a lithium-ion battery or a nickel-hydride battery can be used as the secondary battery 16.

The motor-generator 15 operates in, for example, a regenerative mode to generate electrical power based on torque supplied from the driving wheels 12 when the vehicle 100 is decelerating, and charges the secondary battery 16 based on the generated electrical power.

Additionally, the motor-generator 15 operates in, for example, a power running mode to generate torque based on DC power output from the secondary battery 16, and to transfer the generated torque to the engine 11 via the second pulley P2, the belt 15a, and the first pulley P1, thus assisting torque of the engine 11.

The above motor-generator 15 is called, for example, an Integrated Starter Generator (ISG).

The electrical loads 17 installed in the vehicle 100 include, for example, auxiliary devices. The auxiliary devices include an air-conditioning unit for controlling the temperature and humidity within the cab of the vehicle 100, and an electrical power-steering unit for assisting the driver's effort of turning the steering wheel of the vehicle 100. The secondary battery 16 outputs the DC power and supplies the DC power to the electrical loads 17. The motor-generator 15 is also capable of supplying the generated electrical power to the electrical loads 17.

Additionally, the vehicle 100 includes a brake system 55 for applying, according to an actual position or stroke of a driver-operable brake pedal of the vehicle 100, brake force to each wheel of the vehicle 100 to slow down the vehicle 100.

The vehicle 100 also includes various types of sensors 150 serving as means for measuring the operating conditions of each of the engine 11, the transmission 13, the clutch 14, the motor-generator 15, and the vehicle 100. The sensors 150 are communicably coupled to the control apparatus 10.

For example, the sensors 150 according to the first embodiment include a crank-angle sensor, a cam-angle sensor, a throttle-position sensor, a rotational-angle sensor, a current sensor, an accelerator sensor, a brake sensor, a shift position sensor, a vehicle speed sensor, and an acceleration sensor.

The crank-angle sensor is operative to output, to the control apparatus 10, a measurement signal indicative of the rotational speed of the engine 11 according to the rotational angle, i.e. crank angle, of the output shaft 11a of the engine 11.

The cam-angle sensor is operative to measure the rotational position of each of the camshafts, and output, to the control apparatus 10, a measurement signal indicative of the measured rotational position of each of the camshafts.

The throttle position sensor is operative to measure the actual position, i.e. the opening, of the throttle valve TV, and output, to the control apparatus 10, a measurement signal indicative of the measured position of the throttle valve TV.

The rotational angle sensor is operative to measure the rotational angle of the rotor, and output, to the control apparatus 10, a measurement signal indicative of the measured rotational angle of the rotor of the motor-generator 15.

The current sensor is arranged to measure values of multiphase alternating currents actually flowing through the respective multiphase armature windings of the stator of the motor-generator 15. The current sensor is operative to output, to the control apparatus 10, a measurement signal indicative of the measured value of the alternating current flowing through each of the multiphase armature windings of the stator.

The accelerator sensor is operative to measure the actual position or stroke of the accelerator pedal, and output, to the control apparatus 10, a measurement signal indicative of the measured actual stroke or position of the accelerator pedal.

The brake sensor is operative to measure the actual position or stroke of the brake pedal, and output, to the control apparatus 10, a measurement signal indicative of the measured actual stroke or position of the brake pedal.

The shift position sensor is operative to measure the position of a driver-operable shift lever, which represents a desired torque ratio (gear ratio) of the transmission 13 of a driver of the vehicle 100, and output, to the control apparatus 10, a measurement signal indicative of the measured shift-lever position.

The vehicle speed sensor is operative to measure the speed of the vehicle 100, and output, to the control apparatus 10, a measurement signal indicative of the measured speed of the vehicle 100.

The acceleration sensor is operative to measure the acceleration, i.e. the lateral acceleration, acting on the vehicle 100, and output, to the control apparatus 10, a measurement signal indicative of the measured acceleration acting on the vehicle 100.

The control apparatus 10 is designed as, for example, a typical microcomputer circuit comprised of, for example, a CPU, a storage medium including a ROM and a RAM, an input/output (I/O) unit, registers, buses for communicably connecting the CPU, storage medium, I/O unit, registers, and the other peripherals. The typical microcomputer circuit is defined in the first embodiment to include at least a CPU and a main memory, such as a storage medium therefor.

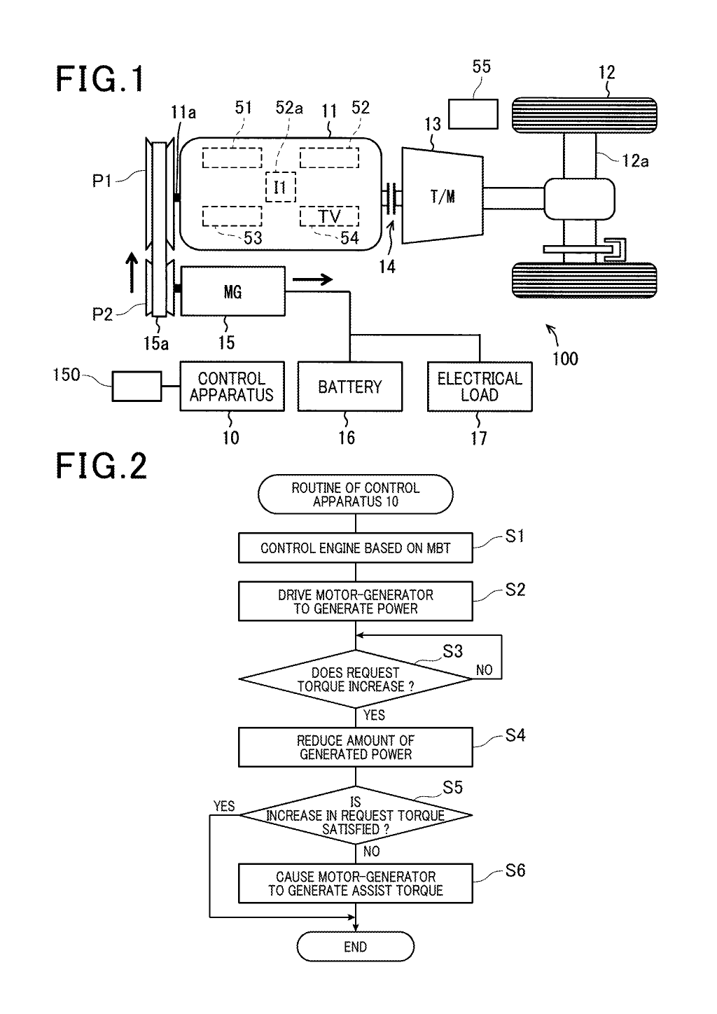

The control apparatus 10 is also communicably coupled to the engine 11, transmission 13, clutch 14, and motor-generator 15 via communication lines and/or buses (not shown in FIG. 1).

The control apparatus 10 receives the measurement signals output from the sensors 150, and determines the operating conditions of each of the engine 11, transmission 13, clutch 14, motor-generator 15, and vehicle 100. Then, the control apparatus 10 performs, in accordance with one or more control programs, i.e. routines, stored in the storage medium and/or the registers, various tasks for controlling the engine 11, the transmission 13, the clutch 14, and the motor-generator 15 using

(1) The determined operating conditions of each of the engine 11, transmission 13, clutch 14, motor-generator 15, and vehicle 100

(2) Various pieces of data stored in the storage medium and/or the registers.

For example, the various tasks include an intake-quantity control task, a fuel injection control task, an ignition timing control task, a motor-generator drive task, a torque-ratio control task, and a clutch control task.

The intake-quantity control task is designed to adjust the actual position of the throttle valve TV to control the quantity of intake air into the engine 11. The fuel injection control task is designed to adjust the fuel injection timing for each cylinder to proper timing, and adjust the injection quantity for the fuel injector for each cylinder to a proper quantity. The ignition timing control task is designed to adjust the ignition timing of each igniter 52a for igniting the compressed air-fuel mixture or the mixture of the compressed air and fuel in a corresponding one of the cylinders at proper timing. The ignition timing for each cylinder is represented as, for example, a crank angle of the output shaft 11a for the corresponding cylinder with respect to the top dead center (TDC) of the corresponding cylinder.

The motor-generator drive task is designed to control how to drive the motor-generator 15. The torque-ratio control task is designed to adjust the torque ratio of the transmission 13, and the clutch control task is designed to control whether the clutch 14 is engaged for transfer of driving torque to the driving wheels 12 or disengaged for interruption of transfer of driving torque to the driving wheels 12.

Specifically, the control apparatus 10 obtains total request torque for the engine 11 for example according to

(1) Driver's request torque based on the actual position or stroke of the accelerator pedal

(2) The actual throttle position of the throttle valve TV

(3) The actual rotational speed of the engine 11

(4) Additional request torque sent via the communication lines or buses from another device installed in the vehicle.

Then, the engine control apparatus 10 performs, according to the total request torque, the intake-quantity control task, which adjusts the actual position of the throttle valve TV, and the ignition timing control task, which controls the ignition timing of each igniter 52a for a corresponding one of the cylinders. This adjusts the output torque of the engine 11 such that the output torque of the engine 11 follows the total request torque.

In particular, the control apparatus 10 according to the first embodiment is configured to store, in the storage medium, information I1. The information I1 represents the correlations between

(1) Best torque, i.e. maximum torque, with best fuel consumption

(2) The quantity of intake air into the engine 11 based on the actual throttle position of the throttle valve TV

(3) The actual rotational speed of the engine 11.

That is, the control apparatus 10 is configured to calculate, according to the information I1 stored in the storage medium, the optimum point of the ignition timing for each igniter 52a of the ignition system 52. The optimum point of the ignition timing matches with the quantity of intake air into the engine 11 based on the actual throttle position of the throttle valve TV and the actual rotational speed of the engine 11.

Specifically, the actual point of the ignition timing adjusted to the optimum point thereof results in best torque, i.e. maximum torque, and best fuel consumption of the engine 11. Then, the control apparatus 10 controls the actual point of the ignition timing for each igniter 52a of the ignition system 52 according to the calculated optimum point of the ignition timing for the corresponding igniter 52a. The optimum point of the ignition timing, which is called Minimum advance for the Best Torque, will be referred to as optimum ignition timing MBT hereinafter.

The following describes a first output-torque control task carried out by the control apparatus 10 with reference to FIG. 2. The control apparatus 10 is programmed to perform the first output-torque control task at short intervals while the control apparatus 10 is powered on, i.e. an ignition switch of the vehicle 100 is powered on.

When starting a routine stored in the storage medium, which corresponds to the first output-torque control task, the control apparatus 10 obtains, from the information I1, an optimum point, which is referred to as the optimum ignition timing MBT; the optimum ignition timing MBT matches with an actual value of the total request torque in step S1. Then, the control apparatus 10 controls the engine 11 to adjust the actual point of the ignition timing of each igniter 52a to the optimum ignition timing MBT, i.e. the corresponding crank angle with respect to the corresponding TDC in step S1.

Next, the control apparatus 10 controls the motor-generator 15 to cause the motor-generator 15 to generate a predetermined amount of electrical power based on torque generated by the engine 11 in step S2. That is, the operation in step S2 enables the power generation by the power-generator 15 to consume part of torque generated by the engine 11 while the actual point of the ignition timing of each igniter 52a is set to the optimum ignition timing MBT. This enables torque reserve, i.e. torque margin, to be achieved.

Following the operation in step S2, the control apparatus 10 determines whether the total request torque increases in step S3. When it is determined that the total request torque increases (YES in step S3), the routine proceeds to step S4. Otherwise, when it is determined that the total request torque is kept unchanged or decreases (NO in step S3), the routine repeatedly performs the determination in step S3 until there is an increment in the total request torque.

In step S4, the control apparatus 10 controls the motor-generator 15 such that the motor-generator 15 reduces the amount of electric power generated thereby. In step S4, the process of reducing the amount of electric power generated by the motor-generator 15 includes a process of reducing the amount of electric power generated by the motor-generator 15 to zero, that is, stopping power generation of the motor-generator 15.

The operation reducing the amount of electric power generated by the motor-generator 15 enables torque consumed by the motor-generator 15 to decrease, thus increasing torque used for running the vehicle 100. This increase in the torque used for running the vehicle 100 aims to meet the increase in the total request torque.

In step S5, the control apparatus 10 determines whether the increase in the torque used for running the vehicle 100 based on the operation in step S4 satisfies the increase in the total request torque.

When it is determined that the increase in the torque used for running the vehicle 100 based on the operation in step S4 satisfies the increase in the total request torque (YES in step S5), the control apparatus 10 terminates the routine.

Otherwise, when it is determined that the increase in the torque used for running the vehicle 100 based on the operation in step S4 fails to satisfy the increase in the total request torque (NO in step S5), the routine proceeds to step S6. Note that there may be a case where the reduction in the amount of electric power generated by the motor-generator 15 is insufficient to satisfy, i.e. fails to satisfy, the increase in the total request torque while the actual point of the ignition timing of each igniter 52a is adjusted to the optimum ignition timing MBT.

In step S6, the control apparatus 10 controls the motor-generator 15 to generate assist torque that compensates for the torque deficiency relative to the increased total request torque, thereafter terminating the routine. Specifically, in step S6, the control apparatus 10 causes the motor-generator 15 to serve as a motor to generate torque and to output the generated torque to the output shaft 11a of the engine 11 via the first and second pulleys P1 and P2 and the belt 15a. This assists the engine 11 in generation of torque. After completion of the operation in step S6, the control apparatus 10 terminates the routine.

To sum up, the control apparatus 10 according to the first embodiment causes the motor-generator 15, which is mechanically coupled to the engine 11, to generate electric power while maintaining the actual point of the ignition timing to the optimum ignition timing MBT. In other words, the control apparatus 10 according to the first embodiment causes the motor-generator 15 to generate electric power without retarding the actual point of the ignition timing from the optimum ignition timing MBT. This enables torque to be reserved without retardation of the actual point of the ignition timing from the optimum ignition timing MBT. Additionally, the control apparatus 10 according to the first embodiment causes the motor-generator 15 to generate torque for assisting torque generated by the engine 11 when the amount of torque reserved based on the power generation of the motor-generator 15 is lower than the total request torque.

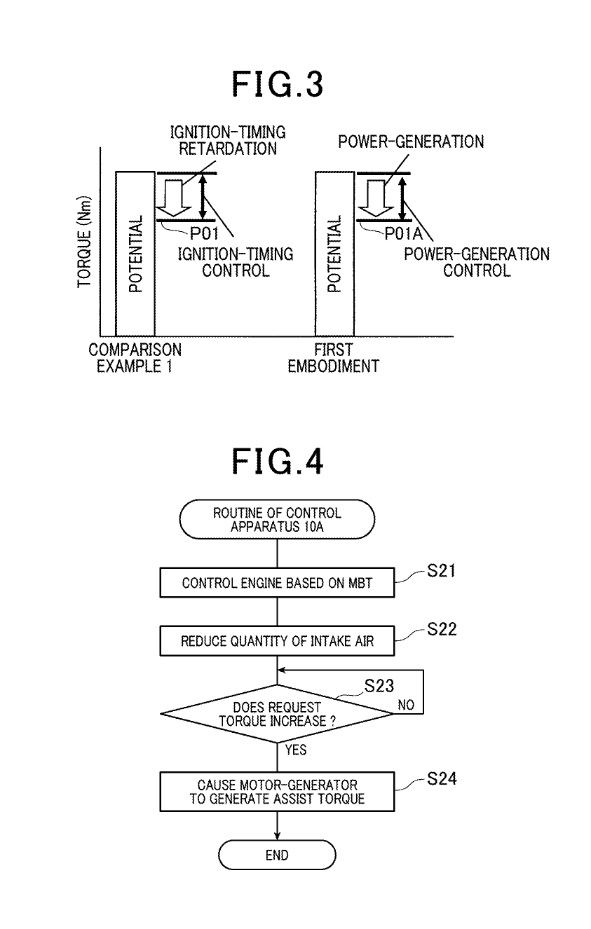

Next, the following describes how torque generated by the engine 11 changes according to the first embodiment in comparison to how torque generated by the same engine 11 changes according to a comparison example 1 with reference to FIG. 3. The comparison example 1 differs from the first embodiment in that the control apparatus according to the comparison example 1 retards the actual point of the ignition timing from the optimum ignition timing MBT to reserve torque.

As described above, the control apparatus according to the comparison example 1 retards the actual point of the ignition timing from the optimum ignition timing MBT to reserve torque. This ignition-timing retardation, i.e. ignition-timing control, reduces torque output from the engine 11 relative to maximum torque outputtable from the engine 11 when the ignition timing is adjusted to the optimum ignition timing MBT. Then, the control apparatus according to the comparison example 1 advances the actual point of the ignition timing toward the optimum ignition timing MBT in response to an increase of the total request torque. Note that FIG. 3 illustrates the maximum torque using the word “potential”, and reference character PO1 represents that the actual torque output from the engine 11 in the comparison example 1; the output torque PO1 is lower than the maximum torque.

Unfortunately, fuel consumption by the engine 11 at the ignition timing retarding from the optimum ignition timing MBT is greater than fuel consumption by the engine 11 at the ignition timing adjusted to the optimum ignition timing MBT.

In contrast, the control apparatus 10 according to the first embodiment causes the motor-generator 15 to generate electric power, thus reserving torque. This power generation, i.e. power-generation control, also reduces torque output from the engine 11 relative to the maximum torque outputtable from the engine 11, enabling reserve torque to be achieved. The maximum torque is torque output from the engine 11 when the ignition timing is adjusted to the optimum ignition timing MBT.

Then, the control apparatus 10 according to the first embodiment reduces the amount of electric power generated by the motor-generator 15 in response to an increase of the total request torque. In FIG. 3, reference character PO1A represents that the actual torque output from the engine 11 in the first embodiment; the output torque PO1A is also lower than the maximum torque.

The control apparatus 10 according to the first embodiment maintains best fuel consumption by the engine 11, because the control apparatus 10 according to the first embodiment adjusts the actual point of the ignition timing to the optimum ignition timing MBT.

The above control apparatus 10 according to the first embodiment controls the engine 11 to adjust the actual point of the ignition timing of each igniter 52a to the optimum ignition timing MBT without retarding the actual point of the ignition timing from the optimum ignition timing MBT. This prevents deterioration of fuel economy of the engine 11 due to retardation of the actual point of the ignition timing from the optimum ignition timing MBT.

If the control apparatus 10 adjusted the actual point of the ignition timing of each igniter 52a to the optimum ignition timing MBT without reserving torque, no torque reserving would have difficulty of immediately responding to an increase of the total request torque.

In view of these circumstances, the control apparatus 10 according to the first embodiment is configured to cause the motor-generator 15 to generate electrical power based on torque output from the engine 11 that is operating at the optimum ignition timing MBT of the ignition timing. This enables part of the torque generated by the engine 11 operating at the optimum ignition timing MBT to be unused for the running of the vehicle 100. This therefore reserves the part of the torque generated by the engine 11 operating at the optimum ignition timing MBT as reserve torque.

Then, the control apparatus 10 reduces the amount of electric power generated by the motor-generator 15 in response to an increase of the total request torque for the engine 11 that is operating at the optimum ignition timing MBT. This enables control of the motor-generator 15, which has higher responsivity of output torque of the engine 11 to an increase of the total request torque than intake-air control, to assist the output torque of the engine 11 even if the output torque of the engine 11 operating at the optimum ignition timing MBT is insufficient.

In other words, the control apparatus 10 is configured to store energy, which was conventionally reserved by the retardation of the actual point of the ignition timing from the optimum ignition timing MBT in preparation for sudden change of the total request torque, into the secondary battery 16 as electrical energy. This therefore achieves higher fuel economy.

Additionally, the control apparatus 10 causes the motor-generator 15 to assist output torque of the engine 11 without adjusting the quantity of intake air into the engine 11 for increase in the output torque. This prevents time loss due to suction of air into the engine 11 from occurring, thus achieving higher responsivity of output torque of the engine 11 to change of the total request torque.

The control apparatus 10 according to the first embodiment reduces the amount of electrical power generated by the motor-generator 15 in response to an increase of the total request torque, i.e. to acceleration of the vehicle 100. The control apparatus 10 however can increase the amount of electrical power generated by the motor-generator 15 in response to a decrease of the total request torque, i.e. deceleration of the vehicle 100. This efficiently increases electrical energy stored in the secondary battery 16 based on a part of torque, which is unused for running the vehicle 100.

As described above, the control apparatus 10 according to the first embodiment is capable of efficiently controlling output torque of the engine 11 in response to both acceleration of the vehicle 100 and deceleration of the vehicle 100.

Additionally, the control apparatus 10 can be configured to efficiently control output torque of the engine 11 while the RPM of the engine 11 is unstable. For example, the control apparatus 10 can be configured to efficiently control output torque of the engine 11 while adjusting the opening of the throttle valve TV to a minimum value to thereby control the engine 11 to be idling.

When determining that the vehicle 100 should be idling, the control apparatus 10 adjusts the opening of the throttle valve TV to the minimum value, thus causing the engine 11 to be idling. While causing the engine 11 to be idling, the control apparatus 10 controls the motor-generator 15 to cause the motor-generator 15 to generate assist torque for assisting output torque of the engine 11 being idling. This supports the RPM of the engine 11 being idling, resulting in more stable rotation of the engine 11. Supporting the RPM of the engine 11 reduces redundant fuel, which was conventionally used for stabilizing rotation of the engine 11 during idling. The control apparatus 10 according to the modification therefore achieves rotation of the engine 11 to be more stable using control of the motor-generator 15; control of the motor-generator 15 has higher responsivity of output torque of the engine 11 to change of the total request torque than intake-air control.

### Second Embodiment

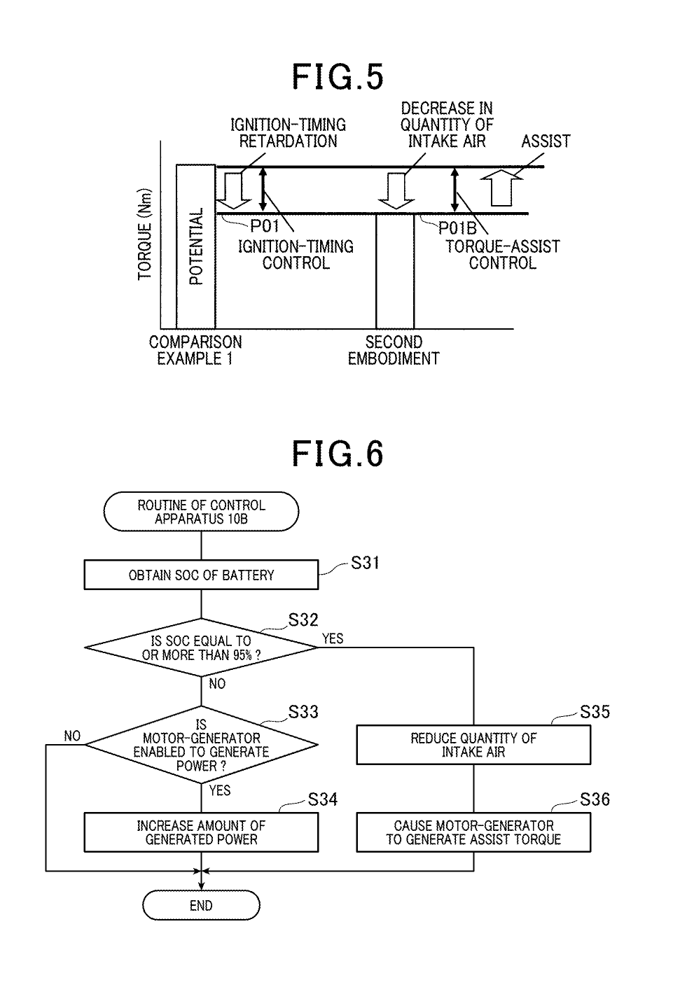

The following describes a control system according to the second embodiment of the present disclosure with reference to FIGS. 4 and 5.

The structure and/or functions of the control system according to the second embodiment are different from the control system according to the first embodiment by the following points. So, the following mainly describes the different points.

A control apparatus, to which reference numeral 10A is assigned, of the control system according to the second embodiment is specially configured to adjust the actual point of the ignition timing of the engine 11 to the optimum ignition timing MBT. The control apparatus 10A is also configured to reduce the quantity of intake air into the engine 11 to be lower than a required quantity of intake air into the engine 11. The required quantity of intake air is required for achieving the total request torque.

Specifically, the control apparatus 10A according to the second embodiment is programmed to carry out a second output-torque control task with short intervals while the control apparatus 10A is powered on, i.e. the ignition switch of the vehicle 100 is powered on.

When starting a routine stored in the storage medium, which corresponds to the second output-torque control task, the control apparatus 10A performs an operation in step S21, which is substantially identical to the operation in step S1. This adjusts the actual point of the ignition timing of each igniter 52a to the optimum ignition timing MBT, i.e. the corresponding crank angle with respect to the corresponding TDC in step S21.

Next, the control apparatus 10A adjusts the opening of the throttle valve TV such that the quantity of intake air into the engine 11 based on the adjusted opening of the throttle valve TV is lower than the required quantity of intake air into the engine 11 in step S22.

As described above, the required quantity of intake air is required for achieving the total request torque. The operation in step S22 therefore reduces torque to be generated by the engine 11. At that time, the operation in step S22 maintains best fuel consumption of the engine 11, i.e. best fuel economy, because of no retardation of the actual point of the ignition timing from the optimum ignition timing MBT.

Following the operation in step S22, the control apparatus 10A determines whether the total request torque increases in step S23. When it is determined that the total request torque increases (YES in step S23), the routine proceeds to step S24. Otherwise, when it is determined that the total request torque is kept unchanged or decreases (NO in step S23), the routine repeatedly performs the determination in step S23 until there is an increment in the total request torque.

In step S24, the control apparatus 10A controls the motor-generator 15 to generate assist torque that compensates for the torque deficiency relative to the increased total request torque, thereafter terminating the routine. Specifically, in step S24, the control apparatus 10A causes the motor-generator 15 to serve as a motor to generate torque and to output the generated torque to the output shaft 11a of the engine 11 via the first and second pulleys P1 and P2 and the belt 15a. This assists the engine 11 in generation of torque. After completion of the operation in step S24, the control apparatus 10A terminates the routine.

To sum up, the control apparatus 10A according to the second embodiment causes the motor-generator 15 to generate torque for assisting torque generated by the engine 11, because the torque generated by the engine 11 is lower than the total request torque due to the reduction in the quantity of intake air into the engine 11.

Next, the following describes how torque generated by the engine 11 changes according to the second embodiment in comparison to how torque generated by the same engine 11 changes according to the comparison example 1 with reference to FIG. 5.

As described above, the control apparatus according to the comparison example 1 retards the actual point of the ignition timing from the optimum ignition timing MBT to reserve torque. This ignition-timing retardation, i.e. ignition-timing control, reduces torque output from the engine 11 relative to the maximum torque (potential PO1) outputtable from the engine 11 when the ignition timing is adjusted to the optimum ignition timing MBT.

Unfortunately, fuel consumption by the engine 11 at the ignition timing retarding from the optimum ignition timing MBT is greater than fuel consumption by the engine 11 at the ignition timing adjusted to the optimum ignition timing MBT.

In contrast, the control apparatus 10A according to the second embodiment reduces the quantity of intake air into the engine 11 to be lower than the required quantity of intake air into the engine 11. This reduction in the quantity of intake air into the engine 11 reduces torque output from the engine 11 relative to the maximum torque outputtable from the engine 11.

Then, the control apparatus 10A according to the second embodiment causes the motor-generator 15 to generate torque for assisting torque generated by the engine 11. This is because the torque, which is illustrated by PO1B in FIG. 5, generated by the engine 11 is lower than the maximum torque, which is illustrated by the potential PO1, of the engine 11. That is, the maximum torque is obtained by the engine 11 when the actual quantity of intake air into the engine 11 is adjusted to be the required quantity of intake air into the engine 11.

The above control apparatus 10A according to the second embodiment controls the engine 11 to adjust the actual point of the ignition timing of each igniter 52a to the optimum ignition timing MBT without retarding the actual point of the ignition timing from the optimum ignition timing MBT. This prevents deterioration of fuel economy of the engine 11 due to retardation of the actual point of the ignition timing from the optimum ignition timing MBT.

The control apparatus 10A reduces the quantity of intake air into the engine 11 to be lower than the required quantity of intake air into the engine 11; the required quantity of intake air is required for achieving the total request torque. Additionally, the control apparatus 10A is capable of causing the motor-generator 15 to assist output torque of the engine 11. This enables the motor-generator 15 to compensate for insufficiency of torque due to the reduction in the quantity of intake air into the engine 11.

### Third Embodiment

The following describes a control system according to the third embodiment of the present disclosure with reference to FIG. 6.

The structure and/or functions of the control system according to the third embodiment are different from the control systems according to the first and second embodiments by the following points. So, the following mainly describes the different points.

The sensors 150 according to the third embodiment include a charge/discharge current sensor for measuring the values of charge currents used for charging the secondary battery 16, and the values of discharge currents discharged from the secondary battery 16.

A control apparatus, to which reference numeral 10B is assigned, of the control system according to the third embodiment is specially configured to determine whether to cause the motor-generator 15 to generate electric power or generate torque for assisting output torque of the engine 11 according to the charged capacity in the secondary battery 16. For example, the control apparatus 10B according to the third embodiment uses the state of electrical charge (SOC) of the secondary battery 16 as a parameter indicative of the actual charged capacity in the secondary battery 16. That is, the SOC of the secondary battery 16 represents the actual charged capacity as a percentage of the maximum capacity of the secondary battery 16.

Specifically, the control apparatus 10B according to the third embodiment is programmed to carry out a third output-torque control task with short intervals while the control apparatus 10B, which is powered on, is causing the engine 11 to generate electric power at the optimum ignition timing MBT.

When starting a routine stored in the storage medium, which corresponds to the third output-torque control task, the control apparatus 10B obtains the SOC of the secondary battery 16 in step S31. For example, the control apparatus 10B obtains the SOC of the secondary battery 16 according to integration of both

(1) The values of the charge currents charged into secondary battery 16 measured by the charge/discharge current sensor

(2) The values of the discharge currents discharged from the secondary battery 16 measured by the charge/discharge current sensor.

Following the operation in step S31, the control apparatus 10B determines whether the SOC of the secondary battery 16 obtained in step S31 is equal to or higher than 95% in step S32.

When it is determined that the SOC of the secondary battery 16 obtained in step S31 is equal to or higher than 95% (YES in step S32), the routine proceeds to step S35. Otherwise, when it is determined that the

SOC of the secondary battery 16 obtained in step S31 is lower than 95% in step S32), the routine proceeds to step S33. Note that 95% is an example of predetermined threshold percentages. Each of the threshold percentages shows that the secondary battery 16 seems to be substantially fully charged, i.e. the secondary battery 16 is difficult to be charged, or that, if the SOC exceeded the corresponding threshold percentage, the charging efficiency of the secondary battery 16 would be significantly reduced.

Because the SOC of the secondary battery 16 obtained in step S31 is lower than 95% (NO in step S32), the control apparatus 10B determines that the secondary battery 16 has sufficient space to be charged. Then, in step S33, the control apparatus 10B determines whether to enable the motor-generator 15 to generate electric power. When it is determined that the control apparatus 10B enables the motor-generator 15 to generate electric power (YES in step S33), the routine proceeds to step S34. Otherwise, when it is determined that the control apparatus 10B disables the motor-generator 15 from generating electric power (NO in step S33), the control apparatus 10 terminates the routine.

For example, when it is determined that the motor-generator 15 can be used as a motor, the control apparatus 10B determines to enable the motor-generator 15 to generate electric power. Thus, when it is determined that the motor-generator 15 is operating as a motor in response to an increase of the total request torque, the control apparatus 10B disables the motor-generator 15 from generating electric power. Otherwise, when it is determined that reduction of torque generated by the motor-generator 15 has little problem for output torque of the engine 11, the control apparatus 10B enables the motor-generator 15 to generate electric power.

In step S34, the control apparatus 10B controls the motor-generator 15 such that the motor-generator 15 increases the amount of electric power generated thereby. After completion of the operation in step S34, the control apparatus 10B terminates the routine. The task of increasing the amount of electric power, which is carried out by the control apparatus 10B, includes a task of causing the motor-generator 15 to start power generation from the state where the motor-generator 15 stops power generation.

On the other hand, in step S35, the control apparatus 10B determines that there is no need to further charge the secondary battery 16, because the SOC is not less than 95% so that the secondary battery 16 appears to be substantially fully charged. Then, in step S35, the control apparatus 10B adjusts the opening of the throttle valve TV to reduce the quantity of intake air into the engine 11 based on the adjusted opening of the throttle valve TV to be lower than a predetermined optimum quantity of intake air into the engine 11. The control apparatus 10B can determine the optimum quantity of intake air into the engine 11 based on, for example, the total request torque and the operating conditions of the engine 11 in step S35.

The reduction in the quantity of intake air into the engine 11 results in reduction of fuel consumption and in reduction of the output torque of the engine 11.

Thus, the control apparatus 10B controls the motor-generator 15 to generate assist torque that compensates for the torque reduction based on the reduction in the quantity of intake air into the engine 11 in step S36.

Specifically, in step S36, the control apparatus 10B causes the motor-generator 15 to serve as a motor to generate torque and to output the generated torque to the output shaft 11a of the engine 11 via the first and second pulleys P1 and P2 and the belt 15a. This assists the engine 11 in generation of torque. After completion of the operation in step S36, the control apparatus 10 terminates the routine. That is, the control apparatus 10B efficiently uses substantially fully charged power in the secondary battery 16 to perform assist of the output torque of the engine 11, thus compensating for insufficiency of torque due to the reduction in the quantity of intake air into the engine 11.

The above control apparatus 10B according to the third embodiment controls the motor-generator 15 to generate assist torque for assisting output torque of the engine 11 when determining that the SOC of the secondary battery 16 is not less than a selected one of the predetermined threshold percentages. Additionally, the control apparatus 10B causes the motor-generator 15 to serve as a generator when determining that the SOC of the secondary battery 16 is less than a selected one of the predetermined threshold percentages.

This configuration of the control apparatus 10B prevents the secondary battery 16 from being redundantly charged although the secondary battery 16 is sufficiently charged. This configuration of the control apparatus 10B also efficiently uses substantially fully charged power in the secondary battery 16 to reduce the quantity of intake air into the engine 11 and perform assist of the output torque of the engine 11. This increases more fuel economy of the engine 11.

### Fourth Embodiment

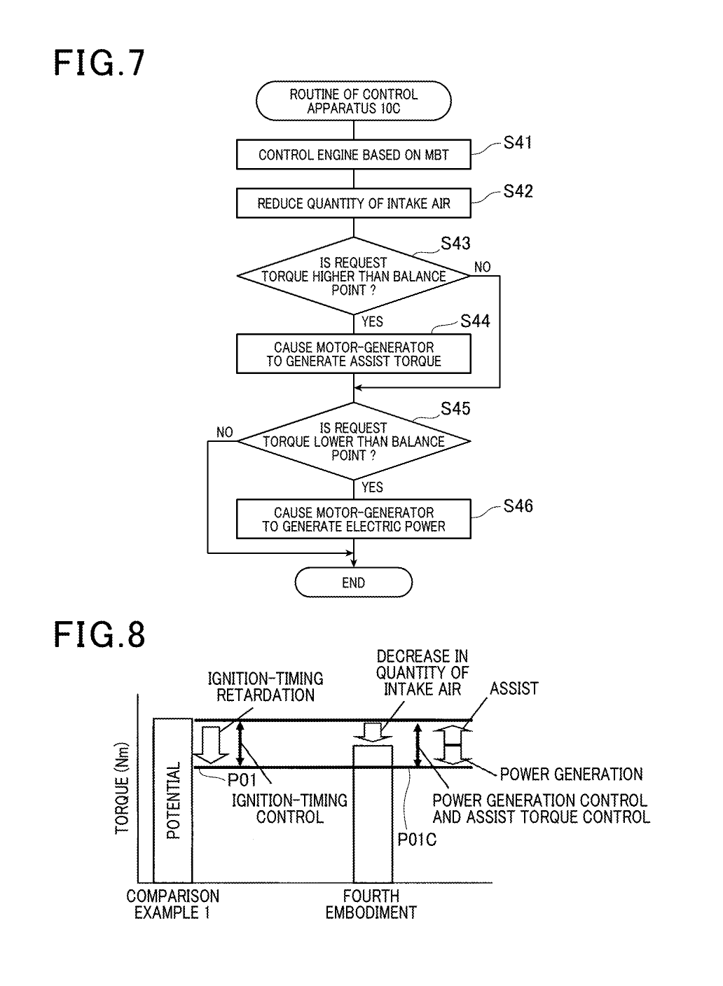

The following describes a control system according to the fourth embodiment of the present disclosure with reference to FIGS. 7 and 8.

The structure and/or functions of the control system according to the fourth embodiment are different from the control systems according to the first to third embodiments by the following points. So, the following mainly describes the different points.

A control apparatus, to which reference numeral 10C is assigned, according to the fourth embodiment is specially configured to adjust the actual point of the ignition timing of the engine 11 to the optimum ignition timing MBT, and reduce the quantity of intake air into the engine 11 to be lower than the optimum quantity of intake air into the engine 11. The control apparatus 10C is also configured to control output torque of the engine 11 based on both adjustment of the amount of electric power generated by the motor-generator 15 and assist torque generated by the motor-generator 15.

Specifically, the control apparatus 10C according to the fourth embodiment is programmed to carry out a fourth output-torque control task with short intervals while the control apparatus 10C is powered on, i.e. the ignition switch of the vehicle 100 is powered on.

When starting a routine stored in the storage medium, which corresponds to the fourth output-torque control task, the control apparatus 10C performs an operation in step S41, which is substantially identical to the operation in step S1. This adjusts the actual point of the ignition timing of each igniter 52a to the optimum ignition timing MBT, i.e. the corresponding crank angle with respect to the corresponding TDC in step S41.

Next, the control apparatus 10C performs an operation in step S42, which is substantially identical to the operation in step S35. This adjusts the opening of the throttle valve TV to reduce the quantity of intake air into the engine 11 based on the adjusted opening of the throttle valve TV to be lower than the predetermined optimum quantity of intake air into the engine 11.

The reduction in the quantity of intake air into the engine 11 relative to the optimum quantity of intake air into the engine 11 results in reduction of fuel consumption and in reduction of the output torque of the engine 11.

Following the operation in step S42, the control apparatus 10C determines whether an actual point of the total request torque is higher than a predetermined balance point of the total request torque in step S43. Note that the balance point of the total request torque represents that

(1) Torque assist by the motor-generator 15 is required if the actual point of the total request torque exceeds the balance point of the total request torque

(2) Power generation by the motor-generator 15 is enabled if the actual point of the total request torque is below the balance point of the total request torque.

In other words, the balance point represents any point of the total request torque at which there are no request of torque assist and no request of power generation.

For example, the control apparatus 10 calculates beforehand the balance point of the total request torque in accordance with the balance between

(1) The previously measured amount of electric power consumed by the assist-torque generation operation of the motor-generator 15

(2) The previously measured amount of electric power generated by the power-generating operation of the motor-generator 15.

As an example, the control apparatus 10C reduces the quantity of intake air into the engine 11 from the predetermined optimum quantity of intake air into the engine 11 down to a predetermined quantity of intake air into the engine 11. The predetermined quantity of intake air into the engine 11 is required for achieving the balance point of the total request torque.

When it is determined that the actual point of the total request torque is higher than the predetermined balance point of the total request torque (YES in step S43), the routine proceeds to step S44. Otherwise, when it is determined that the actual point of the total request torque is equal to or lower than the predetermined balance point of the total request torque (NO in step S43), the routine proceeds to step S45.

In step S44, the control apparatus 10C controls the motor-generator 15 to generate assist torque that compensates for an increase of the actual point of the total request torque relative to the balance point of the total request torque. After completion of the operation in step S44, the routine proceeds to step S45.

That is, controlling the motor-generator 15 to assist the output torque (see PO1C in FIG. 8) of the engine 11 achieves higher responsivity of output torque of the engine 11 in response to an increase of the total request torque relative to the balance point of the total request torque than intake-air control.

In step S45, the control apparatus 10 determines whether the actual point of the total request torque is lower than the predetermined balance point of the total request torque.

When it is determined that the actual point of the total request torque is lower than the predetermined balance point of the total request torque (NO in step S45), the routine proceeds to step S46. Otherwise, when it is determined that the actual point of the total request torque is equal to the predetermined balance point of the total request torque (NO in step S45), the control apparatus 10C terminates the routine.

In step S46, the control apparatus 10C controls the motor-generator 15 such that the motor-generator 15 generates the amount of electric power matching with the actual point of the total request torque. After completion of the operation in step S46, the control apparatus 10C terminates the routine. The power-generation operation in step S46 increases a part of the output torque consumed by the motor-generator 15, resulting in reduction of a part of the output torque used for running the vehicle 100. That is, controlling the motor-generator 15 to reduce the output torque of the engine 11 achieves higher responsivity of output torque of the engine 11 in response to a decrease of the total request torque relative to the balance point of the total request torque than intake-air control.

The above control apparatus 10C according to the fourth embodiment controls the motor-generator 15 to both

(1) Generate assist torque at faster response to an increase of the total request torque

(2) Generate electric power to reduce the output torque of the engine 11 at faster response to a decrease of the total request torque.

Specifically, the control apparatus 10 calculates beforehand the balance point of the total request torque in accordance with the balance between

(1) The previously measured amount of electric power consumed by the assist-torque generation operation of the motor-generator 15

(2) The previously measured amount of electric power generated by the power-generating operation of the motor-generator 15.

Then, the control apparatus 10C reduces the quantity of intake air into the engine 11 from the predetermined optimum quantity of intake air into the engine 11 down to the predetermined quantity of intake air into the engine 11. The predetermined quantity of intake air into the engine 11 is required for achieving the balance point of the total request torque.

Thus, when it is determined that the actual point of the total request torque is higher than the balance point of the total request torque, the control apparatus 10C controls the motor-generator 15 to generate assist torque. The assist torque compensates for an increase of the actual point of the total request torque relative to the balance point of the total request torque. Additionally, when it is determined that the actual point of the total request torque is lower than the balance point of the total request torque, the control apparatus 10C controls the motor-generator 15 such that the motor-generator 15 generates the amount of electric power matching with the actual point of the total request torque.

That is, the control apparatus 10C according to the fourth embodiment increases the amount of electric power generated by the motor-generator 15 when the actual output torque is sufficient to satisfy the actual point of the total request torque. The control apparatus 10C according to the fourth embodiment also increase the amount of assist torque generated by the motor-generator 15 when the actual output torque is insufficient to satisfy the actual point of the total request torque.

Note that the control apparatus 10C according to the fourth embodiment is configured to reduce the quantity of intake air into the engine 11 to be lower than the predetermined optimum quantity of intake air into the engine 11. The present disclosure is however not limited to the configuration.

Specifically, the control apparatus 10C according to the fourth embodiment can be configured to reduce the quantity of intake air into the engine 11 to be lower than a minimum quantity of intake air into the engine 11. The minimum quantity of intake air, which is set to be lower than the optimum quantity of intake air, enables the total request torque to be achieved. This results in reduction of the quantity of intake air into the engine 11, thus increasing more fuel economy of the engine 11.

The present disclosure is not limited to the above first to fourth embodiments, and therefore the first to fourth embodiments can be freely combined with each other or can be modified within the scope of the present disclosure.

The above structures of the first to fourth embodiments are merely typical examples of the present disclosure, and therefore, the scope of claims is not limited to the scope of the first to fourth embodiments. The scope of the present disclosure is defined by the claims. The scope of the present disclosure can include various changes and/or modifications of each of the first to fourth embodiments as long as the various changes and/or modifications mean equivalents of claims and/or the scope of claims.

The vehicle 100 according to each of the first to fourth embodiments includes the parallel hybrid system PHS installed therein, but the vehicle 100 can include a selected one of known hybrid systems, such as a split hybrid system or a series-parallel hybrid system, installed therein.

The vehicle 100 according to each of the first to fourth embodiments includes the motor-generator 15 serving as a power generator and a motor, but the vehicle 100 can include a power generator and a motor individually installed therein as the motor-generator 15.

The motor-generator 15 according to each of the first to fourth embodiments is mounted in the vehicle 100 so as to be coupled to the engine 11 via the first and second pulleys P1 and P2 and the belt 15a, but the present disclosure is not limited thereto. For example, the motor-generator 15 can be installed in or attached to, for example, the transmission 13, the driving shaft 12a, or at least one of the wheels of the vehicle 100.

The motor-generator 15 according to each of the first to fourth embodiments is coupled to the belt system including the first and second pulleys P1 and P2 and the belt 15a, but can be coupled to the engine 11 via another system, such as a gear mechanism including gears.

The control apparatus 10 according to the first embodiment is configured to control the engine 11 to adjust the actual point of the ignition timing of each igniter 52a to the optimum ignition timing MBT at which the maximum torque is achieved. The present disclosure is however not limited thereto. Specifically, the control apparatus 10 can be configured to control the engine 11 to adjust the actual point of the ignition timing of each igniter 52a to a desired point, i.e. a predetermined point, of the ignition timing at which relatively high torque, which is lower than the maximum torque, is achieved. The control apparatus 10 according to this modification can be configured to adjust the actual point of the ignition timing of each igniter 52a to the optimum ignition timing MBT in response to an increase of the request torque, or cause the motor-generator 15 to generate assist torque in response to an increase of the request torque.

While the illustrative embodiments of the present disclosure have been described herein, the present disclosure is not limited to the embodiments described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A system for controlling an engine that ignites an air-fuel mixture to generate torque, the system comprising:
a power generator;
a secondary battery chargeable by the power generator; and
an apparatus configured to:
control the engine to adjust an actual point of ignition timing of the air-fuel mixture to a desired point of the ignition timing;
cause the power generator to generate electric power based on output torque of the engine, the output torque of the engine being generated while the actual point of the ignition timing is set to-the desired point of the ignition timing; and
adjust an amount of the electric power generated by the power generator while the actual point of the ignition timing of the engine is set to the desired point of the ignition timing, thus changing the output torque of the engine.

2. The system according to claim 1, wherein the desired point of the ignition timing is an optimum point of the ignition timing at which a maximum value of the output torque is generated by the engine.

3. The system according to claim 2, wherein the control apparatus is configured to control the engine to adjust the actual point of ignition timing of the air-fuel mixture to the optimum point of the ignition timing and to reduce the quantity of intake air into the engine to be lower than a predetermined optimum quantity of intake air into the engine.

4. A system for controlling an engine that ignites an air-fuel mixture to generate torque, the system comprising:
a power generator;
a secondary battery chargeable by the power generator;
a motor configured to generate, based on output power of the secondary battery, torque for the engine; and
an apparatus configured to:
control the engine to adjust an actual point of ignition timing of the air-fuel mixture to a desired point of the ignition timing and to reduce a quantity of intake air into the engine to be lower than a predetermined quantity of intake air into the engine;
cause the power generator to generate electric power based on output torque of the engine, the output torque of the engine being generated while the actual point of the ignition timing is set to-the desired point of the ignition timing; and
adjust an amount of the torque generated by the motor while the actual point of the ignition timing of the engine is set to-the desired point of the ignition timing, thus changing the output torque of the engine.

5. The system according to claim 4, wherein the apparatus is configured to adjust both the amount of the torque generated by the motor and the amount of the electric power generated by the power generator while the actual point of the ignition timing of the engine is set to the desired point of the ignition timing, thus changing the output torque of the engine.

6. The system according to claim 4, wherein the control apparatus is configured to cause the engine to be idling, and cause the motor to generate assist torque for assisting the output torque of the engine while the engine is idling.

7. The system according to claim 4, wherein the desired point of the ignition timing is an optimum point of the ignition timing at which a maximum value of the output torque is generated by the engine.

8. The system according to claim 7, wherein the control apparatus is configured to control the engine to adjust the actual point of ignition timing of the air-fuel mixture to the optimum point of the ignition timing and to reduce the quantity of intake air into the engine to be lower than a predetermined optimum quantity of intake air into the engine.

9. The system according to claim 4, wherein the control apparatus is configured to:
measure an actual charged capacity of the secondary battery;
determine whether the actual charged capacity is equal to or higher than a predetermined threshold capacity;
cause the motor to generate assist torque for the engine when it is determined that the actual charged capacity is equal to or higher than the threshold capacity; and
cause the power generator to increase the electric power generated by the power generator when it is determined that the actual charged capacity is lower than the threshold capacity.

10. The system according to claim 4, wherein the power generator and motor constitute a single motor-generator so that the motor-generator serves as both the power generator and the motor.
